(19) United States
(12) Patent Application Publication
(10) Pub. No.: US 2009/0116591 A1
(43) Pub. Date: May 7, 2009

(54) SPECTRAL DECOMPOSITION OF LARGE SIGNALS IN A NARROW-RANGE SAMPLING SYSTEM

(76) Inventors: Marlin Viss, Santa Ross, CA (US); David Leyba, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/935,088

(22) Filed: Nov. 5, 2007

(51) Int. Cl. H04L 27/06

(52) U.S. Cl. 375/343

(57) ABSTRACT

A sampling method that determines the deterministic and random components of a signal when the magnitude of the signal exceeds the range of the sampler.

### BACKGROUND

Separating a signal into random and deterministic portions has become standard practice in the field of jitter measurements. This is often done using spectral analysis, a technique where the frequency spectrum of a sequence of jitter samples is obtained and the peaks (deterministic) portion of the spectrum are separated from the floor (random) of the spectrum, shown in U.S. Pat. No. 7,206,340, “Characterizing Jitter of Repetitive Patterns”.

Many of these jitter measurement systems are based on targeted sampling where the timing of one or more edge-detecting samples are targeted at the expected location of the edge, and the value of the samples is used to determine the amount of deviation of the actual edge from the nominal (targeted) location. The targeted sample approach is limited in the range of jitter that can be measured. If the jitter is larger than the range of detection, e.g. larger than the rise time of the signal, some of the jitter samples will be clipped. FIG. 1 illustrates the case where the jitter of the signal exceeds the measurement range. If a particular edge happens to fall outside the range of the edge locator, the precise timing of the edge will be unknown.

While the preceding discussion is focused on jitter measurements, this problem exists any time the amplitude of a signal exceeds the range of some sort of sampling device. FIG. 2 illustrates the general case of a signal having an amplitude that is too large for a sampler.

FIG. 3 shows a device for modifying the sample range. Signal under test x is added to offset signal c to form signal y. Signal y is then sampled by a sampler of limited range to produce a sequence of samples. If the amplitude of signal y exceeds the range of the sampler, some values of the sampled sequence will be clipped. When the offset signal c is adjusted, the portion of the original signal x that will fall within the range of the sampler.

FIG. 4 shows a similar device that can be used to adjust the range of the edge detecting system. The signal under test is supplied to an edge detecting system that is triggered by a trigger signal that is synchronous with the nominal edge position. If the jitter of the signal under test exceeds the range of the edge detecting system, some of the edge times will be clipped. The portion of the jitter that will fall within the range of the edge detecting system can be adjusted by introducing the variable delay signal.

For the system shown in FIGS. 3 and 4, a scheme for dithering the offset signal or delay signal such that the spectral information from the (partially clipped) sequence of samples or edges times is desired.

### SUMMARY

A sampling method that determines the deterministic and random components of a signal when the magnitude of the signal exceeds the range of the sampler. A pseudo-random sequence determines the delay. The samples are acquired according to the delay. Next, it is determined which samples are clipped. Two sequences are generated and autocorrelated. An unclipped autocorrelation sequence is generated, followed by transformation into the frequency domain and analysis of the power spectrum.

### BRIEF DESCRIPTION OF THE DRAWINGS

FIG. 1 illustrates the jitter of a signal exceeding the measurement range.

FIG. 2 illustrates the amplitude of a signal exceeding the range of the sampler.

FIG. 3 illustrates a device modifying the sample range of the prior art.

FIG. 4 illustrates a device modifying the edge detecting range of the prior art.

FIG. 5 illustrates a functional block diagram according to the invention.

FIG. 6 illustrates a process flowchart according to the invention.

FIG. 7 illustrates an embodiment dividing the jitter into non-overlapping ranges.

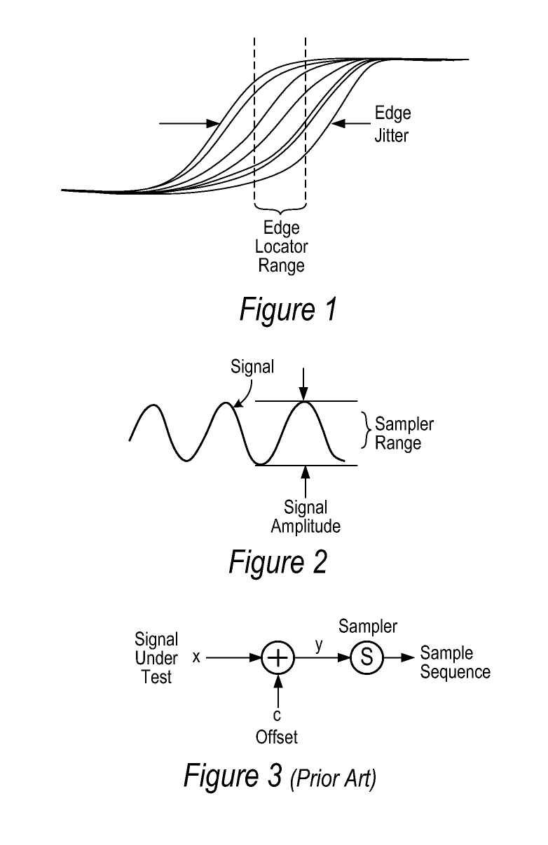

### DETAILED DESCRIPTION

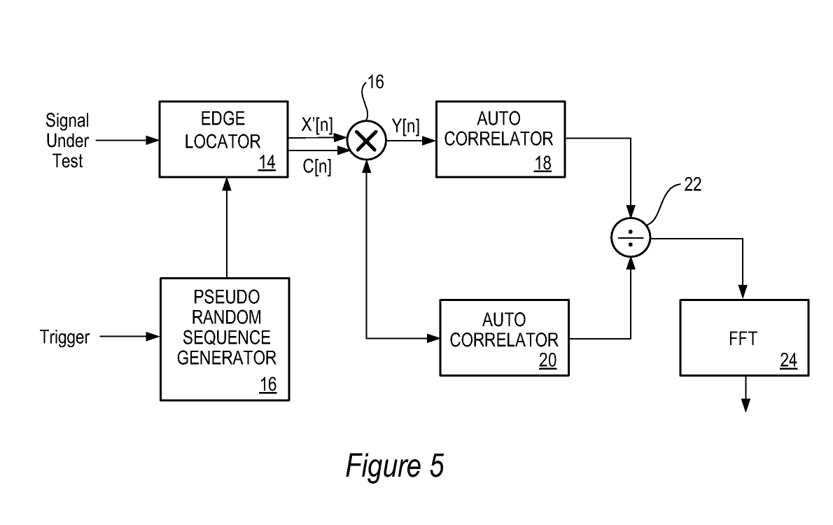

FIG. 5 illustrates a functional block diagram 10 according to the invention. A pseudo-random delay sequence generator 12 receives a trigger signal. An edge locator 14 receives the signal under test (SUT) and the output of the pseudo-random delay sequence generator 12. The edge locator 14 outputs two signals: x′ [n] and c[n]. x′ [n] is the clipped measured output signal while c[n] indicates the clipped sequence. A mixer 16 receives both x′[n] and c[n] as inputs. A first autocorrelator 18 receives the output of the mixer 16, signal y[n]. A second autocorrelator 20 receives c[n]. A divider 22 receives the outputs of the first and the second autocorrrelators 18, 20. A FFT 24 receives the output of the divider 22. The power spectrum of the FFT may be subsequently analyzed (not shown).

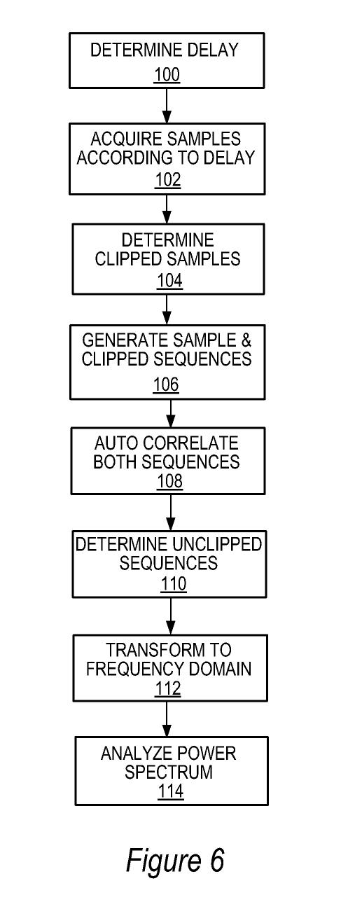

FIG. 6 illustrates a process flowchart according to the invention. In step 100, a pseudo-random sequence d[n] that will be applied to the delay is determined. The sequence must have a uniform distribution and be spectrally flat. In step 102, samples are acquired at the offset indicated by the pseudo-random sequence. In step 104, it is determined which samples are clipped. In step 106, two sequences y[n] and c[n] are generated. In step 108, y[n] and c[n] are autocorrelated. In step 110, the autocorrellated c[n] is divided into the autocorrelated y[n] to determine the unclipped sequence Rxx[m]. In step 112, the unclipped sequence Rxx[m] is transformed into frequency domain to determine the power spectrum. In step 114, power spectrum analysis is performed.

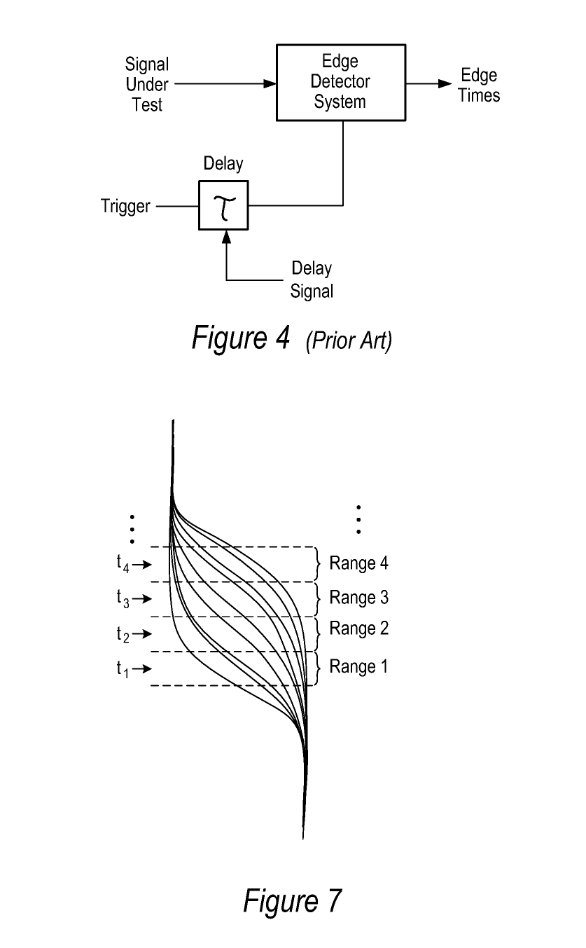

FIG. 7 shows an edge that has too much jitter to be measured by a targeted edge detector. The jitter is divided into multiple contiguous non-overlapping regions, Rangeⱼ. Each region is less than or equal to the maximum range of the edge locator. For each region, an associated delay value tⱼ is supplied to the system shown in FIG. 4 to cause the edge locator's range to be equal to Rangeⱼ. While the illustrative example shows delays selected among discrete values that result in “non-overlapping regions” of the edge, the delays chosen can alternatively be continuous, provided they are still spectrally flat.

To sample the jitter sequence x[n], where x[n] is the deviation of edge n from the ideal location, the system of FIG. 4 is supplied a sequence of delays d[n] where each d[n] is chosen from among the delays {t₁, t₂, t₃, . . . } of FIG. 5. The samples sequence y[n] is given by:

$$y [ n ] = \{ \begin{matrix} x [ n ] \text{:} x [ n ] ∈ \{ Range\_given \_by \_d [ n ] \} \\ 0 \text{:} otherwise\end{matrix} \qquad Equation 1$$

The sequence c[n] is introduced. c[n] has the value 0 when the sample y[n] is clipped and 1 when y[n] is not clipped. y[n] can be expressed as

y[n]=x[n]c[n] Equation 2

If the values of d[n] are randomly chosen with equal probability from among the delays {t₁, t₂, t₃, . . . }, the autocorrelation sequence Rxx(m) of the length N jitter sequence x[n] may be estimated as:

$${R}_{xx} [ m ] = \frac{{R}_{yy} [ m ]}{{R}_{cc} [ m ]} = \frac{{\sum }_{n = 1}^{N} x [ n ] c [ n ] x [ n + m ] c [ n + m ]}{{\sum }_{n = 1}^{N} c [ n ] c [ n + m ]} \qquad Equation 3$$

By transforming the autocorrelation sequence into the frequency domain, an estimate of the power spectrum of the jitter signal is obtained which may be used to separate the random and deterministic components of the jitter.

While the technique has been described with respect to a jitter measurement device, the approach is equally applicable to an amplitude measurement device.

We claim:

1. A method comprising:
determining a parameter;
acquiring samples according to the parameter;
determining which samples are clipped generating a sampled sequence and a clipped sequence;
autocorrelating the sampled sequence and the clipped sequence;
determining an unclipped autocorrelation sequence;
transforming the unclipped autocorrelation sequence into the frequency domain; and
analyzing the power spectrum.

2. A method as in claim 1, wherein the parameter is selected from a group including offset and delay.

3. A method as in claim 2, wherein:
the parameter is delay; and
determining a delay comprises generating a pseudo-random sequence.

4. A method as in claim 3, wherein the pseudo-random sequence has a uniform distribution and is spectrally flat.

5. A method as in claim 4, wherein the pseudo-random sequence includes delays that have non-overlapping regions.

6. A method as in claim 4, wherein the pseudo-random sequence includes delays that have overlapping regions.

7. A method as in claim 1, determining the unclipped autocorrelation sequence by dividing the clipped autocorrelation sequence into the sampled autocorrelation sequence.
